(19) United States
(12) Patent Application Publication
(10) Pub. No.: US 2026/0254824 A1
(43) Pub. Date: Aug. 27, 2026

(54) SYSTEM FOR PRIVACY-PRESERVING ZERO-DAY THREAT DETECTION IN ENCRYPTED TRAFFIC USING FEDERATED GRAPH NEURAL NETWORKS

(71) Applicant: Kiran Kumar Reddy PAKKIR, Glen Allen, VA (US)

(72) Inventor: Kiran Kumar Reddy PAKKIR, Glen Allen, VA (US)

(21) Appl. No.: 19/652,978

(22) Filed: Apr. 20, 2026

(51) Int. Cl. H04L 9/40

(52) U.S. Cl. CPC H04L 63/1416; H04L 63/0428

(57) ABSTRACT

A system and method for privacy-preserving real-time zero-day threat detection in encrypted network traffic using federated temporal graph neural networks with integrated explainable artificial intelligence is disclosed. The system comprises a network interface controller configured to receive encrypted packet streams, a metadata extraction unit configured to derive non-payload attributes without decrypting packet contents, and a temporal graph construction unit configured to generate a dynamic graph representation of communication entities and their time-varying interactions. A plurality of distributed graph processing devices perform iterative message passing operations on the temporal graph, and a federated coordination processor aggregates locally computed model parameter updates using a secure aggregation unit without accessing raw data. An inference processor applies the aggregated model to detect anomalous communication patterns indicative of zero-day threats, while an explainability processor determines contribution scores of graph components to generate interpretable outputs.

### TECHNICAL FIELD OF THE INVENTION

The present invention relates generally to the field of computer and network security, and more particularly to a hardware-implemented system and method for detecting cyber threats within encrypted communication environments. The invention specifically addresses real-time intrusion detection in network traffic wherein packet payloads remain encrypted, and analysis is performed using non-payload metadata and communication patterns.

### Background of the Invention

With the rapid proliferation of encrypted communication protocols across enterprise and public networks, conventional cybersecurity monitoring systems face significant limitations in inspecting packet payloads for identifying malicious activities. Traditional intrusion detection systems rely heavily on deep packet inspection, signature-based detection, or rule-based anomaly detection, which become ineffective when traffic is encrypted using modern cryptographic standards. As a result, malicious actors increasingly exploit encrypted channels to propagate zero-day threats, including advanced persistent threats, polymorphic malware, and coordinated botnet activities.

Existing approaches that attempt to analyze encrypted traffic typically depend on statistical heuristics or shallow machine learning techniques applied to flow-level features. However, such approaches lack the ability to capture temporal dependencies and relational structures inherent in network communication patterns. Furthermore, centralized machine learning models introduce privacy concerns, as sensitive metadata may be aggregated and processed in a single location, increasing vulnerability to data leakage and regulatory non-compliance.

Graph-based learning methods have emerged as promising tools for modeling complex network interactions, but their deployment in real-time, distributed, and privacy-sensitive environments remains limited. Additionally, most existing systems lack interpretability, making it difficult for network administrators to understand the reasoning behind threat detections, thereby reducing trust and hindering actionable response. Accordingly, there exists a need for a hardware-implemented system capable of analyzing encrypted network traffic in real time, preserving data privacy through decentralized learning, capturing temporal graph dynamics, and providing explainable outputs for zero-day threat detection.

The rapid expansion of digital communication networks, cloud infrastructures, and Internet-of-Things ecosystems has significantly increased both the scale and complexity of cybersecurity threats, necessitating the development of advanced intrusion detection systems capable of identifying malicious activities in real time. Traditionally, network security has relied on intrusion detection systems that monitor traffic patterns, system logs, and communication flows to identify unauthorized or suspicious behavior. These systems have evolved through multiple generations, including signature-based, anomaly-based, heuristic-based, and machine learning-driven approaches. While each of these techniques has contributed to improving detection capabilities, they exhibit substantial limitations when applied to modern encrypted network environments and zero-day threat scenarios.

Signature-based intrusion detection systems remain one of the earliest and most widely deployed solutions due to their efficiency in identifying known attack patterns. These systems operate by comparing observed traffic against a predefined database of signatures corresponding to previously identified threats. However, their fundamental limitation lies in their inability to detect novel or zero-day attacks, as such attacks do not yet have associated signatures. Additionally, there exists an inherent delay between the discovery of a new threat and the creation and deployment of its signature, during which systems remain vulnerable. This lag significantly undermines their effectiveness in rapidly evolving threat landscapes. Furthermore, attackers can exploit encryption and obfuscation techniques to conceal malicious payloads, rendering signature matching ineffective when packet contents are not accessible.

Anomaly-based detection systems were introduced to overcome the limitations of signature-based approaches by modeling normal system behavior and identifying deviations from this baseline. While such systems are capable of detecting previously unseen attacks, they suffer from high false-positive rates due to the dynamic and constantly evolving nature of network traffic. Variations in legitimate user behavior, changes in application usage patterns, and environmental fluctuations often trigger false alarms, leading to alert fatigue among security operators. Moreover, anomaly detection systems require extensive training data to establish accurate behavioral baselines, and this training process is computationally intensive and time-consuming. The need for continuous retraining further increases operational complexity and resource consumption.

Another critical limitation of existing machine learning and federated learning-based solutions is their inability to effectively capture the temporal and relational structure of network communications. Most traditional approaches treat network traffic as independent flows or aggregated statistics, ignoring the inherent graph-like relationships between communicating entities and the evolution of these relationships over time. This lack of structural awareness reduces the ability of such systems to detect coordinated or multi-stage attacks, which often manifest as subtle changes in communication patterns rather than isolated anomalies. Additionally, many existing models rely on a limited set of features, which restricts their ability to comprehensively characterize complex network behaviors.

Another significant drawback in current intrusion detection systems is the lack of interpretability and explainability. Many advanced machine learning and deep learning models operate as black boxes, providing predictions without meaningful explanations of how those predictions were derived. This lack of transparency reduces trust among cybersecurity analysts and hinders effective incident response, as operators are unable to understand the underlying causes of detected anomalies. In critical infrastructures and regulated environments, the absence of explainable outputs also poses challenges for compliance, auditing, and forensic analysis.

Additionally, existing systems are vulnerable to evasion techniques employed by sophisticated attackers. Techniques such as payload obfuscation, traffic fragmentation, and encryption can bypass detection mechanisms by exploiting weaknesses in pattern matching and feature extraction processes. Attackers can also generate large volumes of benign-looking traffic to overwhelm detection systems, leading to degraded performance or missed detections. Such evasion strategies highlight the need for more robust and adaptive detection mechanisms capable of operating effectively under adversarial conditions.

While significant advancements have been made in intrusion detection technologies, existing solutions suffer from multiple critical limitations, including inability to analyze encrypted traffic effectively, dependence on centralized data processing, high false-positive rates, lack of scalability, insufficient modeling of temporal and relational dynamics, vulnerability to adversarial evasion, and absence of explainability. These shortcomings underscore the need for a new generation of systems that integrate privacy-preserving distributed learning, temporal graph-based modeling, and interpretable decision-making to enable accurate and real-time detection of zero-day threats in modern encrypted network environments.

### Summary of the Invention

The present invention addresses the aforementioned limitations by providing a system and method for detecting zero-day threats in encrypted network environments through a privacy-preserving, distributed, and interpretable computational framework. The system comprises a network-connected hardware apparatus including a packet acquisition interface, a metadata extraction circuitry, a temporal graph construction unit, a federated model training controller, and a graph-based inference processor.

The metadata extraction circuitry is configured to derive non-payload features from encrypted packets, including temporal intervals, packet sizes, directional flow indicators, and session-level identifiers. These features are supplied to the temporal graph construction unit, which dynamically constructs a time-evolving graph structure wherein nodes represent communication entities and edges represent interactions parameterized by temporal and statistical attributes.

A federated learning controller is operatively connected to a plurality of distributed edge processing nodes, each comprising a local graph neural computation circuit. The controller coordinates decentralized training of a temporal graph neural network by aggregating model updates transmitted from the edge nodes without requiring transfer of raw data, thereby preserving privacy. Secure aggregation circuitry ensures that intermediate model parameters are encrypted during transmission and combined without exposing individual contributions.

The graph-based inference processor executes a trained temporal graph neural network model to classify network behavior patterns and identify anomalies indicative of zero-day threats. An explainability engine, implemented as a dedicated attribution computation circuit, generates interpretable outputs by identifying influential nodes, edges, and temporal sequences contributing to the detection decision. The system further includes a response interface configured to trigger alerts or mitigation actions based on detected threats.

The primary object of the present invention is to provide a technically advanced system and method for detecting zero-day threats in encrypted network traffic without requiring decryption of packet payloads, thereby ensuring preservation of data confidentiality while enabling effective real-time cybersecurity monitoring. Another object of the invention is to implement a hardware-oriented architecture capable of extracting and processing non-payload metadata from encrypted communications to derive meaningful indicators of malicious activity without compromising privacy or violating data protection requirements.

A further object of the invention is to provide a distributed learning mechanism based on federated computation, wherein multiple network-connected processing devices collaboratively train a threat detection model without sharing raw traffic data, thereby reducing risks associated with centralized data aggregation and ensuring compliance with privacy regulations. Another object of the invention is to incorporate a temporal graph-based representation of network interactions, wherein communication entities and their time-varying relationships are modeled to capture complex behavioral patterns and enable identification of coordinated and evolving attack sequences that are not detectable using conventional flow-based analysis.

Another object of the invention is to provide a dedicated graph neural computation mechanism configured to process dynamic graph structures in real time, thereby enabling efficient analysis of large-scale network traffic with reduced latency and improved detection accuracy. A further object of the invention is to include a secure aggregation arrangement configured to combine model updates from distributed nodes using cryptographic techniques, thereby preventing exposure of sensitive intermediate information during federated training.

An additional object of the invention is to provide an integrated explainability mechanism implemented through a hardware-based attribution computation arrangement, which is capable of generating interpretable outputs identifying influential communication patterns, nodes, and temporal sequences contributing to a detected threat, thereby improving transparency, trust, and usability of the system for network administrators and security analysts. Another object of the invention is to enable adaptive learning and continuous model refinement based on real-time network behavior, thereby maintaining robustness against evolving threat landscapes and reducing susceptibility to evasion techniques.

A further object of the invention is to provide a scalable and modular system architecture that can be deployed across heterogeneous network environments including enterprise networks, cloud infrastructures, and edge-based communication systems, while maintaining consistent performance and interoperability. Another object of the invention is to minimize computational overhead and communication latency by utilizing optimized hardware components for graph processing, temporal aggregation, and distributed model coordination, thereby ensuring suitability for real-time applications.

Yet another object of the invention is to provide an automated alert generation and response triggering mechanism that facilitates timely mitigation of detected threats, thereby reducing potential damage caused by cyberattacks. Finally, it is an object of the invention to provide a technically robust, privacy-preserving, and interpretable cybersecurity solution that overcomes the limitations of existing intrusion detection systems and enables reliable detection of previously unknown threats in encrypted network environments.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for privacy-preserving real-time zero-day threat detection in encrypted network traffic; and

FIG. 2 displays flow chart of a method for privacy-preserving real-time zero-day threat detection in encrypted network traffic.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms "comprises", "comprising", or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by "comprises...a" does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

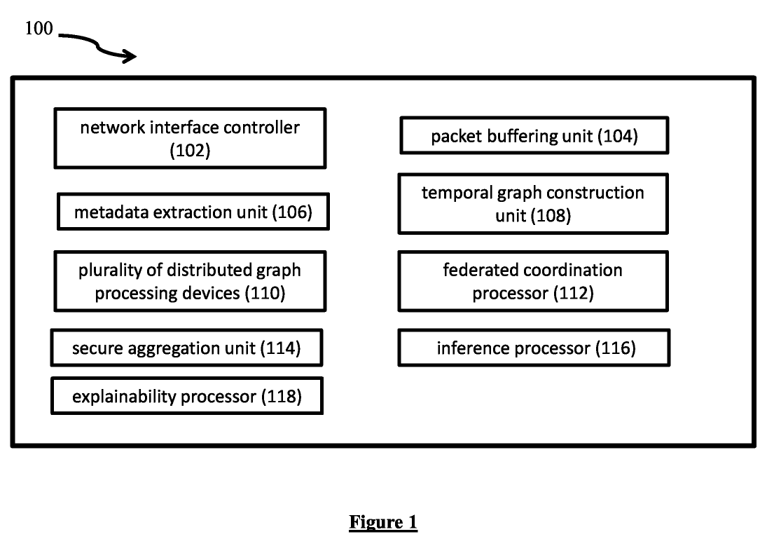

Referring to FIG. 1, a block diagram of a system for privacy-preserving real-time zero-day threat detection in encrypted network traffic is illustrated. The system 100 comprising: a network interface controller (102) configured to receive encrypted packet streams from one or more communication channels; a packet buffering unit(104) operatively coupled to the network interface controller and configured to temporarily store incoming packets; a metadata extraction unit (106)connected to the packet buffering unit and configured to derive non-payload attributes including packet size, inter-arrival time, directional indicators, and session identifiers; a temporal graph construction unit (108) operatively connected to the metadata extraction unit and comprising a memory structure and a time-indexed adjacency generation processor configured to construct and continuously update a dynamic graph representation of communication entities and their temporal interactions; a plurality of distributed graph processing devices(110) each comprising a graph computation processor configured to perform iterative message passing operations on the dynamic graph representation; a federated coordination processor(112) configured to communicate with the plurality of distributed graph processing devices through a secure communication interface and to aggregate model parameter updates without receiving raw data; a secure aggregation unit(114) associated with the federated coordination processor and configured to encrypt and combine parameter updates using masking and accumulation circuitry; an inference processor(116) configured to apply aggregated model parameters to newly constructed temporal graph data to detect anomalous communication patterns; and an explainability processor(118) operatively connected to the inference processor and configured to determine contribution scores of nodes, edges, and temporal sequences associated with detected anomalies and generate interpretable outputs indicative of zero-day threats.

In an embodiment, the metadata extraction unit (106) comprises a header parsing circuit and a timing analysis circuit, wherein the header parsing circuit isolates protocol-independent attributes from encrypted packets and the timing analysis circuit computes inter-packet temporal intervals using a hardware timer, thereby enabling feature extraction without accessing encrypted payload contents.

In an embodiment, the temporal graph construction unit(108) further comprises a sliding time window controller implemented using a circular memory buffer and a clock synchronization circuit, wherein the sliding time window controller updates graph edges based on temporally bounded communication events and removes stale interactions beyond a predefined duration to maintain real-time graph relevance.

In an embodiment, each of the distributed graph processing devices (110) comprises a matrix computation array, a temporal aggregation register, and an activation processing unit, wherein the matrix computation array performs neighborhood feature transformations, the temporal aggregation register accumulates sequential interaction information, and the activation processing unit applies non-linear transformations to produce updated node representations.

In an embodiment, the federated coordination processor (112) further comprises a synchronization control unit configured to manage asynchronous update cycles from the plurality of distributed graph processing devices, thereby accommodating heterogeneous processing capabilities and variable network latencies among the distributed devices.

In an embodiment, the secure aggregation unit (114) comprises a cryptographic masking circuit and a homomorphic accumulation register, wherein the cryptographic masking circuit applies randomization to locally computed parameter updates prior to transmission and the homomorphic accumulation register combines masked updates to derive a global model without revealing individual contributions.

In an embodiment, the inference processor (116) comprises a threshold comparison circuit and an anomaly scoring unit, wherein the anomaly scoring unit computes deviation measures based on learned temporal graph patterns and the threshold comparison circuit classifies communication behavior as normal or anomalous based on predefined or dynamically adjusted thresholds.

In an embodiment, the explainability processor (118) comprises a perturbation generation circuit and a sensitivity evaluation unit, wherein the perturbation generation circuit modifies selected nodes and edges within the temporal graph and the sensitivity evaluation unit computes variations in inference outputs to determine relative importance of graph components contributing to detected anomalies.

In an embodiment, further comprising an alert generation unit operatively connected to the inference processor and configured to transmit notification signals to external security systems, and a response interface configured to initiate predefined mitigation actions including traffic isolation or access restriction upon detection of a zero-day threat.

In an embodiment, the network interface controller (102), metadata extraction unit, temporal graph construction unit, federated coordination processor, inference processor, and explainability processor are integrated within a hardware computing apparatus comprising interconnected processing circuits and memory elements, thereby enabling real-time operation with reduced latency and enhanced data privacy without reliance on centralized raw data storage.

In an embodiment, the temporal graph construction unit is further configured to encode each communication event into a multi-dimensional edge representation by sequentially writing temporal stamps, directional indicators, and statistical weights into a structured memory layout, and wherein the time-indexed adjacency generation processor updates edge connectivity by executing a deterministic insertion routine that aligns incoming metadata with pre-existing node identifiers through a hash-based lookup table, followed by conditional edge creation or augmentation depending on whether a prior interaction between corresponding nodes is detected within an active time window.

In an embodiment, the temporal graph construction unit operates by transforming each incoming communication event into a structured edge instance through a controlled encoding sequence executed at the hardware level. Upon receipt of metadata from the metadata extraction unit, the temporal graph construction unit initiates a write operation into a pre-allocated multi-dimensional memory region, wherein separate indexed segments correspond to temporal stamps, directional indicators, and statistical weights. The temporal stamps are generated using a synchronized timing circuit and written into a dedicated temporal register field, while directional indicators are encoded using binary representations corresponding to source-to-destination flow orientation. Statistical weights are computed in real time using accumulation circuits that consider factors such as frequency of occurrence and recentness of interaction, and are subsequently written into weighted memory slots aligned with the corresponding edge entry.

The time-indexed adjacency generation processor then executes a deterministic insertion routine in which the incoming metadata is first mapped to node identifiers using a hash-based lookup table implemented in fast-access memory. The lookup table ensures consistent mapping of communication endpoints to node indices even under high-throughput conditions, thereby preventing duplication or fragmentation of node representations. Once the corresponding node indices are resolved, the processor performs a conditional evaluation by accessing existing adjacency records to determine whether an edge between the identified nodes already exists within the currently active temporal window maintained by the system.

If no prior interaction is detected, the processor allocates a new edge entry by assigning memory locations within the adjacency structure and initializing the associated temporal and statistical fields. Conversely, if an existing edge is identified, the processor updates the corresponding entry by incrementing statistical weights, refreshing temporal stamps, and recalibrating any derived parameters through an in-place update operation, thereby avoiding redundant edge creation. This conditional augmentation ensures that repeated communications between the same entities are compactly represented while preserving their evolving characteristics.

For example, in a scenario where a client device begins communicating intermittently with a server and subsequently increases its communication frequency within a short time span, the deterministic insertion routine continuously updates the same edge entry by modifying its statistical weight and temporal attributes, rather than generating multiple independent edges. This results in a consolidated representation that captures both the intensity and timing of interactions, enabling downstream graph processing units to detect deviations such as sudden surges in communication frequency or irregular directional patterns.

The described encoding and insertion mechanism enables efficient utilization of memory resources while maintaining high fidelity of temporal and relational information. By ensuring that edge updates are performed deterministically and aligned with existing node mappings, the system achieves consistent graph evolution under streaming conditions. This structured representation enhances the ability of subsequent processing stages to accurately model communication dynamics and identify subtle anomalies associated with zero-day threat behavior in encrypted traffic environments.

In an embodiment, the sliding time window controller is further configured to implement a dual-phase update operation comprising a forward insertion phase and a backward pruning phase, wherein the forward insertion phase appends newly observed communication edges into a circular buffer with synchronized timestamp tagging, and the backward pruning phase traverses the buffer using a decremental pointer controlled by a timing circuit to identify and remove edges exceeding a temporal threshold, followed by recalculation of adjacency relationships through a memory compaction routine that preserves contiguous storage of valid graph elements.

In an embodiment, the sliding time window controller operates as a continuous temporal filtering mechanism that maintains only relevant and recent communication interactions within the graph representation through a coordinated dual-phase update operation. During execution, the forward insertion phase is initiated whenever a new communication event is encoded by the temporal graph construction unit, wherein the sliding time window controller writes the corresponding edge entry into a circular buffer structured in a ring memory configuration. Each insertion is accompanied by a timestamp generated from a synchronized timing circuit, and the write operation is directed to a memory location indicated by a rotating head pointer. The circular nature of the buffer ensures that memory allocation remains constant, and when the buffer reaches capacity, new entries overwrite the oldest stored entries in a controlled manner, thereby maintaining uninterrupted operation under high-throughput conditions.

Concurrently, the backward pruning phase is executed as a parallel process governed by a decremental pointer that traverses the circular buffer in reverse chronological order. The timing circuit continuously compares stored timestamps with a dynamically maintained reference time to determine whether individual edge entries exceed a predefined temporal threshold. When such entries are identified, the controller marks them for removal and initiates a deletion routine that invalidates the corresponding memory locations. Following this, a memory compaction routine is executed to reorganize the remaining valid entries, wherein valid edge records are shifted or re-indexed to eliminate gaps created by removed entries, thereby preserving contiguous storage within the buffer and ensuring efficient access patterns for subsequent processing units.

For example, in a network environment where a large number of short-lived communication sessions occur, such as transient client-server exchanges, the forward insertion phase rapidly records each interaction with precise temporal tagging, while the backward pruning phase continuously eliminates interactions that fall outside the active observation window, such as sessions older than a few seconds or minutes. This ensures that the graph representation reflects only the most recent communication behavior, allowing the system to focus on current activity patterns where anomalous behavior is more likely to manifest.

The coordinated operation of insertion and pruning prevents accumulation of obsolete data, reduces memory fragmentation, and ensures that adjacency relationships remain consistent with the current temporal context. By maintaining a dynamically updated and temporally constrained graph, the system enables downstream computation units to process only relevant interactions, thereby improving responsiveness and accuracy in identifying deviations such as sudden bursts of communication, irregular connection patterns, or short-lived anomalous sessions that are indicative of zero-day threats in encrypted network traffic.

In an embodiment, the graph computation processor is further configured to perform node feature transformation by executing a staged computation sequence in which input feature vectors are first loaded into a matrix computation array, followed by a weighted multiplication operation using locally stored parameter matrices, and subsequently accumulated across neighboring nodes through a controlled data propagation path governed by an address generation circuit that dynamically selects adjacent node indices from the adjacency matrix, wherein the aggregated results are stored in temporal registers indexed by sequential time steps.

In an embodiment, the graph computation processor performs node feature transformation through a precisely coordinated staged computation sequence that enables structured propagation of relational and temporal information across the dynamic graph. Upon receiving the graph data, the processor initiates a data loading phase in which input feature vectors corresponding to individual nodes are fetched from memory and aligned within a matrix computation array. This array is organized to support parallel processing, allowing multiple feature elements of a node to be processed simultaneously. Each feature vector is mapped to specific rows within the array, and control signals ensure synchronization of data loading across all active nodes to maintain computational consistency.

Following the loading phase, the processor executes a weighted multiplication operation using parameter matrices stored in local memory registers. These parameter matrices are pre-loaded and updated through the federated coordination process, and they define transformation relationships that capture structural dependencies within the graph. The multiplication operation is carried out in a pipelined manner, wherein each element of the input feature vector is multiplied with corresponding weight values, and intermediate results are accumulated within the computation array. This operation transforms the raw node features into intermediate representations that encode both intrinsic node properties and learned relational characteristics.

Subsequently, the processor initiates a controlled data propagation sequence to aggregate information from neighboring nodes. An address generation circuit dynamically retrieves indices of adjacent nodes from the adjacency matrix maintained by the temporal graph construction unit. Based on these indices, the processor selectively accesses feature representations of neighboring nodes and routes them through a data propagation path designed to ensure orderly aggregation. The propagation path is governed by control logic that sequences the retrieval and accumulation of neighboring node features, thereby preventing conflicts and ensuring that all relevant neighbors contribute to the updated representation of a given node.

The aggregated results from neighboring nodes are then combined with the transformed features of the target node and written into temporal registers that are indexed according to sequential time steps. These temporal registers preserve the state of each node across multiple processing intervals, enabling the processor to maintain continuity in feature evolution over time. For example, if a particular node begins interacting with an increasing number of previously unconnected nodes within a short duration, the aggregation process captures this expansion in connectivity by integrating contributions from all newly connected neighbors, resulting in a distinct shift in the node’s feature representation stored in the temporal registers.

This staged computation sequence ensures that node representations are not only influenced by their own attributes but are also enriched by contextual information derived from their neighborhood and temporal evolution. By dynamically selecting adjacent nodes and aggregating their contributions in a controlled manner, the processor effectively captures complex interaction patterns, such as coordinated communication bursts or gradual network infiltration behaviors. The storage of results in time-indexed registers further allows subsequent processing stages to analyze trends and transitions in node behavior, thereby enabling accurate identification of anomalous patterns associated with zero-day threats in encrypted network traffic.

In an embodiment, the temporal aggregation register is further configured to maintain a rolling sequence of node state representations across multiple time intervals by shifting stored values through a register chain synchronized with a clock signal, and wherein the aggregation operation combines current and prior node states using a controlled accumulation sequence that preserves temporal ordering, thereby enabling the graph computation processor to capture sequential dependencies without overwriting historical state information.

In an embodiment, the temporal aggregation register operates as a time-aware storage and computation structure that preserves the evolution of node representations across successive processing intervals while enabling controlled integration of historical and current information. The register is organized as a chained sequence of storage elements, each corresponding to a discrete time step, and is synchronized by a clock signal that governs periodic shifting of stored values. At each clock cycle, newly computed node representations generated by the graph computation processor are inserted into the leading position of the register chain, while previously stored representations are shifted to subsequent positions, thereby forming a rolling sequence that retains a bounded history of node states.

The aggregation operation is executed through a controlled accumulation sequence in which the current node representation is combined with one or more prior representations retrieved from downstream positions in the register chain. This combination is performed using dedicated accumulation circuits that apply weighted integration while maintaining the original temporal order of the stored values. Control logic ensures that the sequence of accumulation follows a defined temporal progression, preventing reordering or overwriting of earlier states. As a result, each updated node representation reflects not only the most recent interactions but also a structured contribution from preceding time intervals.

For example, in a network scenario where a device gradually increases its communication frequency with a set of endpoints over several time intervals, the temporal aggregation register captures this progression by preserving each intermediate state in the register chain. When the aggregation operation is executed, the current state is combined with prior states to produce a representation that encodes the cumulative behavioral trend rather than a single instantaneous observation. This allows the system to distinguish between transient spikes in activity and sustained behavioral changes, which is particularly important for identifying stealthy or slowly evolving threats.

The synchronized shifting mechanism ensures that the register chain continuously updates in real time without requiring complex memory management, while the controlled accumulation sequence maintains consistency and prevents loss of temporal information. By preserving ordered historical states and integrating them with current computations, the system enables the graph computation processor to model sequential dependencies inherent in network communication patterns. This enhances the ability to detect anomalies that manifest over time, such as gradual lateral movement or staged attack execution, which may not be apparent when analyzing isolated snapshots of network activity.

In an embodiment, the synchronization control unit of the federated coordination processor is further configured to manage asynchronous parameter update reception by assigning sequence identifiers to incoming updates, buffering the updates in a staging memory, and executing an ordering routine that aligns updates based on arrival time and device identity, followed by conditional aggregation once a predefined quorum of updates is reached or a timeout condition is satisfied, thereby enabling coordinated model update cycles under variable communication delays.

In an embodiment, the synchronization control unit operates as a coordination layer that ensures orderly integration of parameter updates received from geographically distributed graph processing devices despite variations in transmission latency and processing speeds. Upon receipt of each parameter update, the synchronization control unit assigns a sequence identifier generated through a monotonic counter or timestamp-based indexing mechanism, thereby uniquely tagging each update with both temporal and source-specific information. The incoming updates are then temporarily stored within a staging memory, which is structured to maintain separate queues indexed by device identity, allowing the system to track contributions from individual processing devices without collision or overwrite.

The synchronization control unit subsequently executes an ordering routine that evaluates the buffered updates by comparing their sequence identifiers and associated device identifiers. This routine aligns updates into a consistent processing order by resolving discrepancies caused by out-of-order arrival, ensuring that updates generated within the same logical training interval are grouped together even if they are received at different times. The ordering process involves scanning the staging memory, reorganizing update entries into a coherent sequence, and marking them as eligible for aggregation once alignment conditions are satisfied.

Following the ordering operation, the synchronization control unit applies a conditional aggregation trigger mechanism. In one condition, aggregation is initiated when a predefined quorum of updates, corresponding to a minimum number of participating devices, has been received and properly aligned. In another condition, aggregation is triggered when a timeout interval, controlled by a timing circuit, expires, ensuring that the system continues operation even if some devices fail to transmit updates within the expected time frame. This dual-condition triggering mechanism prevents indefinite delays in model updates while maintaining sufficient participation for reliable aggregation.

For example, in a distributed deployment where edge devices operate under heterogeneous network conditions, some devices may transmit updates with minimal delay while others experience latency due to bandwidth constraints. The synchronization control unit accommodates these variations by buffering early-arriving updates and aligning them with later arrivals based on sequence identifiers. If a sufficient number of updates is received promptly, aggregation proceeds without waiting for all devices; alternatively, if delays persist, the timeout condition ensures that the system proceeds with available updates, thereby maintaining continuous learning cycles.

The described synchronization mechanism ensures that parameter updates are incorporated in a controlled and temporally consistent manner, preventing inconsistencies that could arise from unordered or incomplete data integration. By managing asynchronous reception through sequence assignment, buffering, and conditional aggregation, the system maintains stability and reliability of the distributed training process, enabling effective model convergence even in environments characterized by variable communication delays and heterogeneous device participation.

In an embodiment, the cryptographic masking circuit is further configured to generate masking values using a pseudo-random sequence derived from a seed stored in a secure register, and to apply the masking values to parameter updates through an element-wise transformation operation prior to transmission, and wherein the homomorphic accumulation register combines the masked updates using additive accumulation while preserving the masked state until a coordinated demasking operation is executed using complementary masking values.

In an embodiment, the cryptographic masking circuit operates as a confidentiality-preserving transformation layer that ensures that parameter updates generated at distributed graph processing devices remain unintelligible during transmission and aggregation. Upon completion of local parameter computation, each update is routed to the masking circuit, where a pseudo-random sequence generator produces a stream of masking values derived from a seed stored within a protected register. The seed is initialized through a secure provisioning process and remains inaccessible to external interfaces, thereby preventing unauthorized reconstruction of the masking sequence. The pseudo-random sequence generator expands the seed into a sequence aligned in dimension with the parameter update, ensuring that each element of the update has a corresponding masking value.

The masking operation is performed through an element-wise transformation in which each parameter value is combined with its corresponding masking value using a predefined arithmetic operation executed within a transformation circuit. This operation is carried out in a parallelized manner across all elements of the parameter update to minimize latency. The resulting masked update is structurally indistinguishable from random data and is transmitted to the federated coordination processor through the communication interface. Since the masking is applied prior to transmission, interception of the data does not reveal meaningful information about the original parameters.

At the federated coordination processor, the homomorphic accumulation register receives masked updates from multiple distributed devices and performs an additive accumulation directly on the masked values. The accumulation process is executed without requiring removal of the masking, as the arithmetic properties of the masking operation allow aggregation to proceed while preserving correctness of the final result. Each incoming masked update is sequentially added to the accumulated value stored in the register, and control logic ensures that all updates corresponding to a particular aggregation cycle are included.

Following completion of accumulation, a coordinated demasking operation is executed using complementary masking values that correspond to the combined masking applied at the distributed devices. These complementary values are derived using synchronized pseudo-random sequences or pre-shared parameters and are applied to the aggregated result to remove the cumulative masking effect. The demasking operation restores the true aggregated parameter values without exposing any individual contribution during the process.

For example, in a scenario where multiple edge devices compute parameter updates based on local graph data, each device applies its own masking sequence before transmission. The aggregation unit combines all masked updates into a single accumulated value, which still retains the combined masking effect. Only after aggregation is complete does the system apply the complementary masking removal, yielding the correct global parameter set. At no point during transmission or intermediate processing are individual updates exposed in their original form.

This approach ensures that distributed learning can be performed collaboratively without compromising confidentiality of local computations. By combining pseudo-random masking with homomorphic accumulation, the system enables secure aggregation of model updates while maintaining correctness and efficiency, thereby supporting privacy-preserving operation in environments where sensitive network behavior data must remain protected.

In an embodiment, the secure aggregation unit is further configured to perform integrity verification of received parameter updates by computing a verification value using a checksum generation circuit and comparing the computed value with a transmitted reference value, and wherein only verified updates are forwarded to the homomorphic accumulation register for inclusion in the aggregated model parameter set.

In an embodiment, the secure aggregation unit incorporates an integrity verification mechanism that operates as a pre-aggregation validation stage to ensure that only authentic and uncorrupted parameter updates are included in the global model computation. Upon reception of each masked parameter update from distributed graph processing devices, the secure aggregation unit routes the update through a checksum generation circuit that computes a verification value based on the received data. The checksum generation circuit executes a deterministic transformation across the entire parameter update, wherein segments of the update are sequentially processed using arithmetic and bitwise operations to produce a compact verification value that uniquely corresponds to the content of the update.

Simultaneously, each transmitted parameter update includes a reference verification value that is generated at the originating device using an identical checksum generation procedure prior to transmission. The secure aggregation unit retrieves this transmitted reference value and performs a comparison operation using a dedicated comparator circuit. The comparison process evaluates whether the locally computed verification value matches the transmitted reference value within a defined tolerance condition, thereby confirming the integrity of the received data.

If the comparison yields a match, the parameter update is marked as valid and is forwarded to the homomorphic accumulation register for inclusion in the aggregation process. Conversely, if a mismatch is detected, the update is flagged as invalid and is excluded from further processing. In such cases, the system may optionally log the occurrence and associate it with the originating device identifier for subsequent evaluation, thereby enabling identification of faulty or potentially compromised nodes within the distributed network.

For example, in a deployment where multiple edge devices transmit parameter updates over unreliable communication channels, data corruption may occur due to transmission errors or interference. The checksum-based verification mechanism detects such corruption by identifying discrepancies between the computed and transmitted verification values, thereby preventing erroneous updates from influencing the aggregated model. Similarly, in scenarios involving adversarial attempts to inject manipulated updates, the verification process acts as a filtering mechanism that blocks unauthorized modifications from entering the aggregation pipeline.

The integration of integrity verification prior to aggregation ensures that the homomorphic accumulation process operates exclusively on validated data, thereby maintaining consistency and reliability of the global model parameters. By preventing inclusion of corrupted or tampered updates, the system preserves the stability of the distributed learning process and enhances resilience against both accidental transmission errors and intentional data manipulation, ensuring that subsequent inference operations are based on trustworthy aggregated information.

In an embodiment, the anomaly scoring unit is further configured to compute deviation measures by executing a comparison routine between current node representations and baseline representations stored in a reference memory, wherein the comparison routine calculates differences across multiple feature dimensions using a parallel evaluation circuit and aggregates the differences into a composite anomaly score using a weighted summation sequence controlled by a programmable register.

In an embodiment, the anomaly scoring unit operates as a multi-dimensional evaluation subsystem that quantifies deviations in node behavior by systematically comparing real-time node representations with historically learned baseline representations stored within a reference memory. Upon receiving updated node representations from the inference processor, the anomaly scoring unit initiates a comparison routine in which corresponding baseline representations are retrieved from the reference memory using node identifiers as indexing keys. These baseline representations are periodically updated during prior learning cycles and reflect statistically stable patterns of normal communication behavior for each node.

The comparison routine is executed using a parallel evaluation circuit configured to process multiple feature dimensions simultaneously. Each feature dimension of the current node representation is aligned with the corresponding dimension of the baseline representation, and a difference value is computed through a subtraction or distance evaluation operation. These computations are carried out in parallel across all dimensions using dedicated arithmetic units, thereby significantly reducing processing latency even for high-dimensional feature vectors. The resulting difference values capture deviations in multiple behavioral aspects, such as changes in communication frequency, variation in interaction diversity, and irregular temporal patterns.

Following computation of per-dimension differences, the anomaly scoring unit performs an aggregation operation using a weighted summation sequence controlled by a programmable register. The programmable register stores weighting coefficients corresponding to each feature dimension, allowing the system to assign greater significance to features that are more indicative of anomalous behavior. During aggregation, each difference value is multiplied by its corresponding weight, and the weighted values are accumulated in a controlled sequence to produce a composite anomaly score for the node. The weighting coefficients can be dynamically adjusted based on system conditions or prior learning, enabling adaptive sensitivity to different types of anomalies.

For example, in a network scenario where a device suddenly increases its communication rate while also interacting with previously unseen endpoints, the parallel evaluation circuit simultaneously detects deviations in both frequency-related and connectivity-related feature dimensions. If the weighting configuration assigns higher importance to abrupt connectivity changes, the aggregation process amplifies the contribution of those dimensions, resulting in a higher composite anomaly score. Conversely, minor fluctuations in less critical features contribute minimally to the final score, thereby reducing the likelihood of false alarms.

The computed composite anomaly score represents a consolidated measure of deviation from expected behavior and is subsequently supplied to the threshold comparison circuit for classification. By leveraging parallel processing and weighted aggregation, the anomaly scoring unit achieves rapid and accurate evaluation of complex behavioral deviations across multiple dimensions. This approach enables the system to detect subtle and multi-faceted anomalies that may not be apparent through single-feature analysis, thereby enhancing the capability to identify zero-day threats embedded within encrypted network traffic.

In an embodiment, the threshold comparison circuit is further configured to dynamically adjust classification thresholds by monitoring historical anomaly scores stored in a buffer memory and applying a recalibration routine that updates threshold values based on statistical distribution characteristics derived from the stored scores, wherein the recalibration routine is executed at periodic intervals determined by a timing controller.

In an embodiment, the threshold comparison circuit operates as an adaptive decision-making component that continuously refines its classification boundary in response to evolving network behavior patterns by utilizing historical anomaly score data. The circuit is coupled with a buffer memory that stores a rolling set of previously computed anomaly scores associated with recent node evaluations, wherein the buffer is updated in real time as new scores are generated by the anomaly scoring unit. Each stored score is indexed with temporal information, allowing the system to distinguish between short-term fluctuations and longer-term behavioral trends.

The recalibration routine is initiated at periodic intervals under the control of a timing controller, which generates trigger signals based on predefined timing cycles or dynamically adjusted intervals depending on system load. Upon activation, the threshold comparison circuit retrieves a subset of historical anomaly scores from the buffer memory and processes them through a statistical evaluation sequence. This sequence involves computing distribution characteristics such as central tendency and dispersion using arithmetic circuits configured to perform averaging, variance estimation, and range determination across the stored values. These computed characteristics provide a quantitative representation of normal variation in anomaly scores under current network conditions.

Based on the derived statistical parameters, the circuit updates the classification threshold by applying a controlled adjustment function implemented through programmable registers. The adjustment function modifies the threshold value to align with the observed distribution, such that the threshold remains sensitive to significant deviations while accommodating normal fluctuations. For instance, if the overall distribution of anomaly scores shifts upward due to increased baseline activity during peak network usage, the recalibration routine correspondingly elevates the threshold to prevent excessive triggering of alerts. Conversely, during periods of low activity where anomaly scores are generally lower, the threshold is reduced to maintain sensitivity to subtle deviations.

The recalibration process is executed in a manner that preserves stability by incorporating smoothing operations, wherein abrupt changes in threshold values are avoided through incremental adjustments over successive recalibration cycles. This ensures that the classification boundary evolves gradually and does not introduce oscillations that could lead to inconsistent detection outcomes. Additionally, the timing controller can adjust the frequency of recalibration based on observed variability in the anomaly score distribution, enabling more frequent updates during dynamic conditions and less frequent updates during stable periods.

For example, in a network environment experiencing periodic bursts of legitimate high-volume traffic, the anomaly scoring unit may produce elevated scores that are nonetheless consistent with normal behavior for that interval. The recalibration routine identifies this shift in distribution and adjusts the threshold upward, thereby preventing misclassification of benign activity as anomalous. As the network returns to typical activity levels, subsequent recalibration cycles lower the threshold accordingly, restoring sensitivity to potential threats.

Through continuous monitoring and statistically guided adjustment of classification thresholds, the threshold comparison circuit maintains an optimal balance between detection sensitivity and false alarm reduction. This adaptive mechanism enables the system to remain effective across varying operational conditions, ensuring that anomaly detection remains accurate and responsive to genuine deviations indicative of zero-day threats in encrypted network environments.

In an embodiment, the perturbation generation circuit is further configured to selectively alter graph components by modifying node feature values, removing or inserting edges, and reordering temporal sequences according to a controlled perturbation schedule stored in a configuration memory, and wherein each perturbation is applied in isolation to generate modified graph instances for evaluation.

In an embodiment, the perturbation generation circuit operates as a controlled graph manipulation mechanism that systematically produces alternative graph instances to enable precise evaluation of how individual components influence detection outcomes. The circuit accesses a configuration memory in which a perturbation schedule is stored, the schedule defining a sequence of modification operations, target graph elements, and execution order. Upon activation, the circuit retrieves the current graph state from shared memory and creates a working copy within a dedicated processing buffer to ensure that the original graph remains unaltered during evaluation.

The perturbation process is executed in a strictly isolated manner, wherein only one modification is applied at a time according to the schedule. For node-level perturbations, the circuit modifies selected feature values by applying controlled adjustments such as scaling, offsetting, or substitution using predefined transformation parameters stored in the configuration memory. For edge-level perturbations, the circuit either removes an existing edge by invalidating its adjacency entry or inserts a synthetic edge by allocating a new entry with specified attributes, ensuring that the modification adheres to structural constraints of the graph. For temporal perturbations, the circuit reorders the sequence of interaction events by altering timestamp indices within the edge records, thereby simulating changes in the temporal progression of communication.

Each modified graph instance is generated independently and stored in a temporary buffer, after which it is forwarded to the inference processor for evaluation. The isolation of perturbations ensures that the effect of each modification can be attributed to a specific graph component without interference from other changes. Control logic within the circuit enforces sequential execution, preventing concurrent perturbations and ensuring reproducibility of results across multiple evaluation cycles.

For example, in a scenario where a particular communication link between two nodes is suspected to contribute to anomalous behavior, the perturbation generation circuit removes that edge in one instance and observes the resulting change in inference output. In another instance, the circuit may alter the feature values of a node representing communication frequency or interaction diversity to assess its influence. Similarly, by reordering temporal sequences, the circuit can evaluate whether the timing of interactions plays a critical role in anomaly detection. Each of these modifications is applied independently, allowing the system to isolate the contribution of individual components.

The controlled perturbation mechanism enables systematic exploration of the graph structure and feature space without disrupting the integrity of the original data. By generating well-defined alternative graph instances and ensuring that each perturbation is applied in isolation, the system provides a reliable basis for subsequent sensitivity evaluation. This approach enhances the ability to identify the specific elements and temporal patterns that drive anomaly detection decisions, thereby supporting accurate interpretation of complex graph-based computations in encrypted network environments.

In an embodiment, the sensitivity evaluation unit is further configured to compute contribution scores by executing a differential analysis routine that measures variations in inference outputs between original and perturbed graph instances, and accumulates the variations across multiple perturbation cycles using an accumulation register to derive stable importance rankings of graph components.

In an embodiment, the sensitivity evaluation unit operates as a quantitative assessment mechanism that determines the relative importance of graph components by analyzing variations in inference outcomes under controlled perturbations. Upon receiving both the original graph instance and a corresponding perturbed graph instance from the perturbation generation circuit, the sensitivity evaluation unit initiates a differential analysis routine in which inference outputs produced for each instance are aligned and compared. These outputs may include anomaly scores, classification values, or intermediate activation states generated by the inference processor. The unit retrieves the original inference output from a reference register and computes the difference between the original and perturbed outputs using arithmetic comparison circuits that operate across all relevant output dimensions.

The computed difference represents the impact of the applied perturbation on the detection outcome, and this value is interpreted as a measure of contribution associated with the specific graph component that was modified. The sensitivity evaluation unit then records this contribution value in an accumulation register indexed by the identifier of the perturbed component, such as a node, edge, or temporal segment. The accumulation register is designed to support repeated updates, allowing contribution values from multiple perturbation cycles to be aggregated over time.

The process is repeated across a sequence of perturbation cycles, each cycle involving a distinct modification as defined by the perturbation schedule. During each cycle, the differential analysis routine computes a new contribution value, which is then added to the previously stored value in the accumulation register. This cumulative aggregation ensures that transient fluctuations in inference outputs caused by isolated perturbations are averaged out, resulting in a more stable and reliable estimation of component importance. Control logic ensures that accumulation is performed in a synchronized manner, preventing overwriting and maintaining consistent indexing of contribution values.

For example, if a particular communication edge consistently causes a significant change in anomaly score when removed across multiple perturbation cycles, the accumulated contribution value associated with that edge increases progressively, indicating its strong influence on the detection decision. Conversely, if perturbations applied to another component result in negligible or inconsistent changes, its accumulated contribution remains low, reflecting limited importance. Similarly, nodes representing endpoints that participate in anomalous communication patterns exhibit higher accumulated contributions due to repeated impact across perturbation evaluations.

After completion of the perturbation cycles, the sensitivity evaluation unit performs a ranking operation in which accumulated contribution values are compared using comparator circuits to establish an ordered list of graph components based on their influence. This ranking is then forwarded to the explainability processor for formatting and interpretation. The use of repeated differential analysis combined with accumulation ensures that importance rankings are not derived from single-instance observations but are instead based on consistent behavior across multiple controlled evaluations.

By systematically measuring output variations and aggregating results over successive perturbations, the sensitivity evaluation unit provides a robust mechanism for identifying the most influential elements within the temporal graph. This enables precise attribution of anomaly detection decisions to specific communication patterns and structural features, thereby supporting deeper analysis of network behavior and facilitating targeted investigation of potential zero-day threats in encrypted traffic environments.

In an embodiment, the alert generation unit is further configured to construct structured notification signals by encoding anomaly scores, contributing graph components, and temporal identifiers into a formatted data packet using a serialization circuit, and to transmit the formatted data packet through a communication interface using a prioritized transmission sequence controlled by a scheduling circuit.

In an embodiment, the alert generation unit operates as a structured data synthesis and transmission mechanism that converts analytical outputs from the inference and explainability processors into standardized notification signals suitable for real-time dissemination to external monitoring and response systems. Upon identification of an anomalous condition, the alert generation unit retrieves the computed anomaly score, the ranked list of contributing graph components, and associated temporal identifiers from shared memory interfaces. These elements are then organized into a predefined data schema maintained within a formatting control register, ensuring that each alert adheres to a consistent structural representation.

The serialization circuit performs a sequential encoding operation in which the retrieved data elements are converted into a contiguous data packet. This involves mapping each parameter to designated fields within the packet structure, applying encoding rules such as fixed-length or variable-length representations, and appending synchronization markers and integrity fields to facilitate reliable transmission and decoding at the receiving end. The serialization process is executed in a pipelined manner, allowing multiple data fields to be processed concurrently while maintaining correct ordering within the output stream. Control signals govern the sequencing of field insertion, ensuring that anomaly scores, component identifiers, and temporal markers are encoded in a deterministic and reproducible format.

Once the data packet is constructed, it is transferred to a communication interface that supports transmission over network or system-level channels. A scheduling circuit associated with the alert generation unit manages the prioritization of outgoing alerts by assigning priority levels based on severity indicators derived from the anomaly score and contextual information. Alerts corresponding to high-severity anomalies are placed at the front of a transmission queue, while lower-priority notifications are deferred until higher-priority transmissions are completed. The scheduling circuit dynamically monitors queue states and transmission bandwidth, adjusting dispatch order to ensure timely delivery of critical alerts without causing congestion or delay.

For example, in a scenario where multiple anomalies are detected simultaneously across different segments of a network, the alert generation unit constructs individual data packets for each event. If one anomaly exhibits a significantly higher deviation score and involves critical communication endpoints, the scheduling circuit assigns it a higher priority and ensures its immediate transmission, while less critical alerts are queued for subsequent dispatch. The structured packet may include identifiers of affected nodes, descriptions of anomalous edges, and timestamps indicating when the behavior was observed, enabling downstream systems to rapidly interpret and respond to the event.

The combined operation of structured serialization and prioritized transmission ensures that alert information is both precise and timely, facilitating seamless integration with external security infrastructure. By encoding detailed contextual information into a standardized format and controlling the order of transmission based on severity, the system enables efficient propagation of actionable intelligence, thereby supporting rapid response to detected anomalies in encrypted network environments.

In an embodiment, the response interface is further configured to execute mitigation actions by generating control signals based on detected anomalies, wherein the control signals are transmitted to a traffic control circuit that identifies associated network flows through a lookup operation on stored session identifiers and applies flow-level modifications including blocking, rate limiting, or rerouting through a programmable switching circuit.

In an embodiment, the response interface operates as an execution layer that translates detection outcomes into actionable control instructions capable of directly influencing network behavior in real time. Upon receipt of an anomaly indication from the inference processor and associated contextual information from the explainability processor, the response interface generates control signals through a decision logic circuit that maps anomaly characteristics, such as severity level, affected nodes, and temporal context, to predefined mitigation actions stored in a policy memory. These control signals are encoded with identifiers corresponding to specific network entities and are transmitted to a traffic control circuit through a dedicated control bus.

The traffic control circuit receives the control signals and initiates a lookup operation using stored session identifiers that were previously derived during metadata extraction and graph construction stages. This lookup is performed using a high-speed associative memory structure that correlates session identifiers with active network flows, including source and destination addresses, port information, and flow state parameters. Once the relevant flows are identified, the traffic control circuit applies flow-level modifications in accordance with the received control instructions.

For blocking operations, the circuit updates forwarding tables within a programmable switching circuit to drop packets associated with the identified flows, effectively terminating communication between the involved endpoints. For rate limiting, the circuit configures bandwidth control registers to restrict the transmission rate of the targeted flows, thereby containing potential threat propagation while maintaining partial connectivity for monitoring purposes. For rerouting actions, the circuit modifies routing paths by updating switching logic to redirect traffic through alternative inspection or quarantine channels, enabling further analysis without disrupting overall network operation.

For example, in a scenario where anomalous communication is detected between two endpoints exhibiting characteristics of lateral movement, the response interface generates a control signal specifying the session identifiers of the involved flows and a corresponding mitigation action. The traffic control circuit identifies the flows using its lookup mechanism and immediately enforces a blocking rule within the programmable switching circuit, preventing further communication. In another scenario, if a flow exhibits suspicious but not conclusively malicious behavior, the system may apply rate limiting to reduce potential impact while continuing observation, or reroute the flow to a monitoring segment for deeper inspection.

The integration of real-time lookup and programmable switching ensures that mitigation actions are applied with minimal delay and high precision, targeting only the affected flows without impacting unrelated network activity. By directly linking detection outputs to hardware-level control of network traffic, the system enables immediate containment of threats and reduces the window of vulnerability, thereby enhancing operational resilience in environments handling encrypted communication streams.

In an embodiment, the federated coordination processor is further configured to perform weighted aggregation of parameter updates by assigning trust scores to distributed graph processing devices based on consistency of historical updates stored in a validation memory, and applying the trust scores as weighting factors during accumulation within the secure aggregation unit to influence the contribution of each device to the global model parameter set.

In an embodiment, the federated coordination processor incorporates a trust-aware aggregation mechanism that refines the contribution of distributed graph processing devices by evaluating the consistency of their historical parameter updates. Upon receipt of parameter updates from multiple devices, the processor accesses a validation memory that maintains a historical record of previously received updates, including statistical descriptors and consistency indicators associated with each device. The processor executes a consistency evaluation routine in which newly received updates are compared against historical update patterns stored for the corresponding device. This comparison is performed using deviation assessment circuits that quantify variations in update magnitude, directional alignment, and temporal stability relative to prior updates.

Based on the outcome of this evaluation, the processor assigns a trust score to each device using a scoring circuit that translates consistency metrics into a numerical weighting factor. Devices exhibiting stable and predictable update behavior over multiple aggregation cycles are assigned higher trust scores, while devices showing irregular, highly variable, or inconsistent updates receive lower scores. The assigned trust scores are stored in a dedicated register set and are updated dynamically as new consistency evaluations are performed over successive training iterations.

During the aggregation phase, the secure aggregation unit incorporates these trust scores as weighting factors in the accumulation process. Each parameter update is multiplied by its corresponding trust score prior to accumulation, and the weighted updates are then combined using the homomorphic accumulation register. This ensures that contributions from highly reliable devices have a greater influence on the resulting global model parameters, while the impact of less reliable or potentially compromised devices is proportionally reduced. The weighting operation is executed in a synchronized manner across all parameter elements to maintain structural integrity of the aggregated model.

For example, in a distributed network where certain edge devices operate in stable environments with consistent traffic patterns, their updates tend to exhibit low variance across training cycles and are therefore assigned higher trust scores. Conversely, devices located in volatile or potentially compromised environments may produce erratic updates due to noise or adversarial manipulation, resulting in lower trust scores. During aggregation, the system amplifies the influence of stable devices while attenuating the contribution of inconsistent ones, thereby producing a more reliable global model.

The use of validation memory for historical tracking enables the processor to continuously refine trust assessments over time, allowing adaptation to changing device behavior. Additionally, by integrating trust-based weighting directly into the aggregation process, the system mitigates the risk of model degradation caused by anomalous or malicious updates without requiring explicit exclusion of participating devices. This approach enhances robustness of the distributed learning process and ensures that the aggregated model remains representative of consistent and trustworthy data contributions across the network.

In an embodiment, all functional elements of the disclosed system are implemented as tangible hardware components configured for real-time operation through dedicated circuitry and physical interconnections. The network interface controller is realized as a physical communication interface circuit comprising transceivers, signal conditioning units, and protocol handling logic to receive encrypted packet streams over wired or wireless links. The packet buffering unit is implemented using high-speed memory elements, including static or dynamic memory arrays, coupled with address decoding logic to enable temporary storage and controlled retrieval of packet data. The metadata extraction unit is formed by hardware parsing circuits and timing circuits, wherein the parsing circuits include logic gates and register arrays configured to isolate header-level attributes, and the timing circuits include clock-driven counters to compute inter-arrival intervals. The temporal graph construction unit is implemented using dedicated memory structures, including adjacency storage arrays and indexing tables, along with arithmetic and control circuitry that perform edge encoding, hashing, and update operations in hardware. The graph computation processor comprises matrix computation arrays, arithmetic logic units, and register banks interconnected through data buses, enabling parallel execution of feature transformation and aggregation operations. The temporal aggregation register is realized as a chain of sequential storage elements such as flip-flops or shift registers synchronized by clock signals to maintain ordered temporal states. The federated coordination processor is implemented as a centralized processing circuit including control logic, buffering memory, and communication interfaces, while the synchronization control unit includes sequencing logic and timing controllers for managing asynchronous data reception. The secure aggregation unit comprises cryptographic circuitry, including masking circuits with pseudo-random sequence generators and accumulation registers configured for arithmetic combination of masked values. The anomaly scoring unit and threshold comparison circuit are implemented using arithmetic processing circuits, comparator units, and programmable registers for executing multi-dimensional evaluation and classification operations. The explainability processor includes perturbation generation circuits and sensitivity evaluation circuits realized through configurable logic blocks and accumulation registers capable of iterative evaluation. The alert generation unit is implemented using serialization circuits, formatting registers, and communication interface hardware for constructing and transmitting structured data packets, while the scheduling circuit comprises queue management logic and priority control registers. The response interface and traffic control circuit are realized through control signal generation logic, lookup memory structures, and programmable switching circuitry capable of modifying network flows at the hardware level. Each of these components is interconnected through physical buses and operates under clock-driven synchronization, ensuring deterministic execution, low latency, and continuous processing capability, thereby providing a fully hardware-based implementation capable of performing the described operations without reliance on abstract or purely software-based constructs.

The network interface controller is implemented as a physical communication interface circuit comprising high-speed transceivers, media access control logic, and direct memory access pathways configured to receive encrypted packet streams and forward them to internal processing units with deterministic latency. The packet buffering unit is realized using high-speed memory elements arranged as FIFO or circular buffers with address control circuitry to temporarily store incoming packets and regulate data flow between acquisition and processing stages. The metadata extraction unit is embodied as a combination of a header parsing circuit and a timing analysis circuit, wherein dedicated logic gates and protocol-agnostic parsing pathways isolate packet attributes, and a hardware timer with counter registers computes inter-arrival intervals without accessing encrypted payloads.

The temporal graph construction unit is implemented using structured memory arrays and a time-indexed adjacency generation processor comprising arithmetic logic circuits, address generation units, and clock-synchronized controllers configured to construct and update graph relationships in real time. Each of the distributed graph processing devices is realized as a hardware computation module including matrix computation arrays, register banks, and activation circuits interconnected through high-throughput data buses, enabling iterative message propagation through parallelized arithmetic operations. The federated coordination processor is embodied as a control circuit with embedded communication transceivers, synchronization logic, and buffer memory configured to coordinate parameter exchange across distributed devices while maintaining isolation of locally processed data.

The secure aggregation unit is implemented using dedicated cryptographic circuitry including masking generators, accumulation registers, and verification logic gates configured to combine parameter updates through controlled arithmetic operations while preserving confidentiality. The inference processor is realized as a hardware evaluation engine comprising parallel comparison circuits, weighted summation units, and threshold detection logic configured to classify communication patterns based on computed anomaly scores. The explainability processor is embodied as a perturbation and sensitivity evaluation module including configurable modification circuits, differential computation units, and accumulation registers configured to determine contribution levels of graph elements through controlled variation and response measurement.

The alert generation unit is implemented as a serialization and transmission circuit comprising encoding logic, packet formatting hardware, and prioritized scheduling controllers configured to generate and dispatch notification signals. The response interface is realized as a control signal generation circuit coupled with programmable switching hardware and lookup memory, enabling enforcement of mitigation actions such as traffic blocking or rerouting. All components are interconnected through physical buses, clock distribution networks, and power management circuits within a unified hardware apparatus, thereby ensuring deterministic, low-latency operation and compliance with enablement requirements through tangible structural implementation.

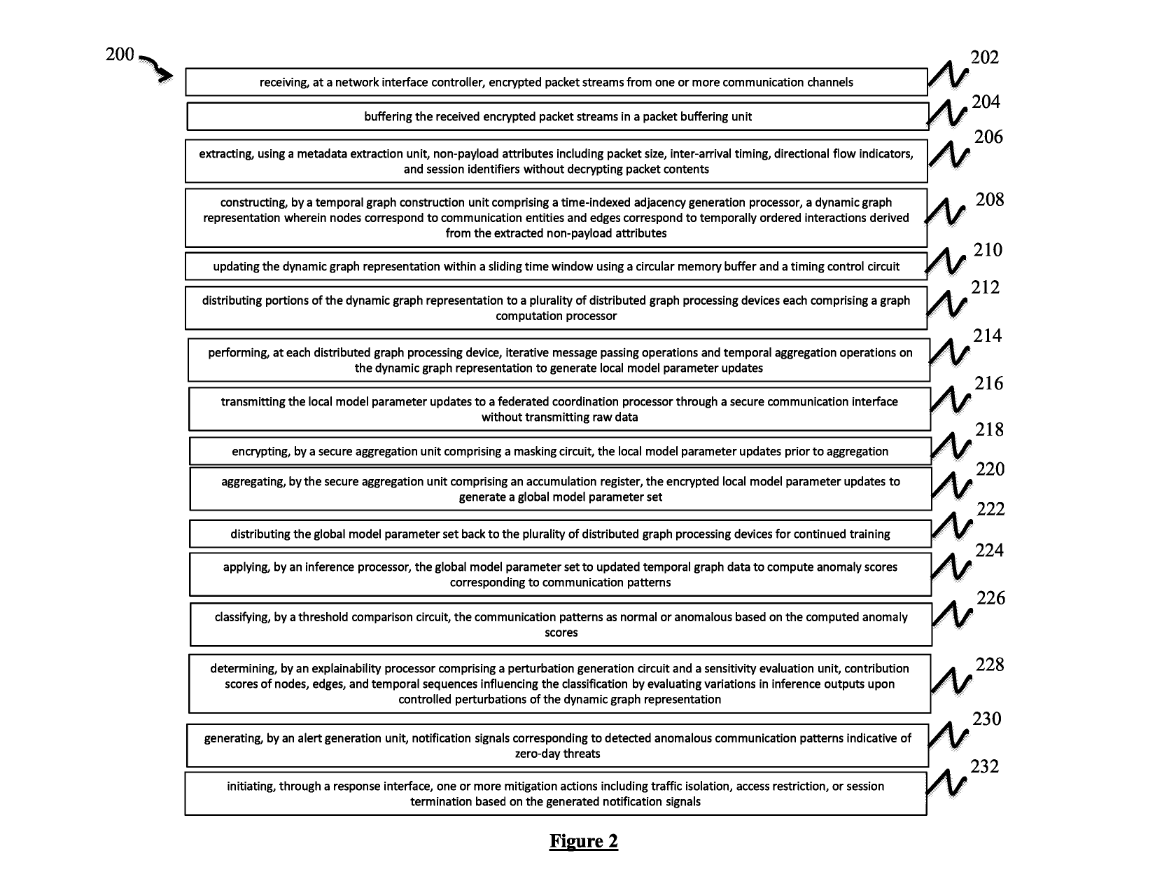

Referring to FIG. 2, a flow chart of a method for privacy-preserving real-time zero-day threat detection in encrypted network traffic, the method comprising, the method is illustrated. The method 200 comprising:

At step 202, the method 200 includes receiving, at a network interface controller, encrypted packet streams from one or more communication channels;

At step 204, the method 200 includes buffering the received encrypted packet streams in a packet buffering unit;

At step 206, the method 200 includes extracting, using a metadata extraction unit, non-payload attributes including packet size, inter-arrival timing, directional flow indicators, and session identifiers without decrypting packet contents;

At step 208, the method 200 includes constructing, by a temporal graph construction unit comprising a time-indexed adjacency generation processor, a dynamic graph representation wherein nodes correspond to communication entities and edges correspond to temporally ordered interactions derived from the extracted non-payload attributes;

At step 210, the method 200 includes updating the dynamic graph representation within a sliding time window using a circular memory buffer and a timing control circuit;

At step 212, the method 200 includes distributing portions of the dynamic graph representation to a plurality of distributed graph processing devices each comprising a graph computation processor;

At step 214, the method 200 includes performing, at each distributed graph processing device, iterative message passing operations and temporal aggregation operations on the dynamic graph representation to generate local model parameter updates;

At step 216, the method 200 includes transmitting the local model parameter updates to a federated coordination processor through a secure communication interface without transmitting raw data;

At step 218, the method 200 includes encrypting, by a secure aggregation unit comprising a masking circuit, the local model parameter updates prior to aggregation;

At step 220, the method 200 includes aggregating, by the secure aggregation unit comprising an accumulation register, the encrypted local model parameter updates to generate a global model parameter set;

At step 222, the method 200 includes distributing the global model parameter set back to the plurality of distributed graph processing devices for continued training;

At step 224, the method 200 includes applying, by an inference processor, the global model parameter set to updated temporal graph data to compute anomaly scores corresponding to communication patterns;

At step 226, the method 200 includes classifying, by a threshold comparison circuit, the communication patterns as normal or anomalous based on the computed anomaly scores;

At step 228, the method 200 includes determining, by an explainability processor comprising a perturbation generation circuit and a sensitivity evaluation unit, contribution scores of nodes, edges, and temporal sequences influencing the classification by evaluating variations in inference outputs upon controlled perturbations of the dynamic graph representation;

At step 230, the method 200 includes generating, by an alert generation unit, notification signals corresponding to detected anomalous communication patterns indicative of zero-day threats; and

At step 232, the method 200 includes initiating, through a response interface, one or more mitigation actions including traffic isolation, access restriction, or session termination based on the generated notification signals.

In an embodiment, extracting the non-payload attributes further comprises isolating protocol header fields using a header parsing circuit and computing inter-packet arrival intervals using a hardware timing circuit, wherein the extracted attributes are normalized and encoded into fixed-length feature vectors prior to graph construction.

In an embodiment, constructing the dynamic graph representation further comprises assigning hashed identifiers to communication entities using a hashing circuit and storing adjacency relationships in a memory-backed matrix structure, wherein each edge is annotated with temporal stamps and statistical weights derived from packet sequences.

In an embodiment, updating the dynamic graph representation within the sliding time window further comprises discarding obsolete edges exceeding a predefined temporal threshold and recalibrating edge weights based on frequency and recency of interactions using a weighted accumulation circuit.

In an embodiment, performing the iterative message passing operations further comprises transforming node feature vectors using a matrix multiplication circuit, aggregating neighboring node features using a temporal aggregation register, and applying non-linear transformations using an activation processing circuit to generate updated node states across sequential time intervals.

In an embodiment, transmitting the local model parameter updates further comprises applying a compression operation using a data reduction circuit prior to encryption, thereby reducing communication overhead between the distributed graph processing devices and the federated coordination processor.

In an embodiment, encrypting the local model parameter updates further comprises applying randomized masking values generated by a pseudo-random number generation circuit, wherein the masking values are removed only after aggregation to prevent exposure of individual updates.

In an embodiment, aggregating the encrypted local model parameter updates further comprises performing weighted accumulation based on trust scores assigned to each distributed graph processing device using a validation circuit configured to assess consistency of received updates.

In an embodiment, applying the global model parameter set further comprises computing anomaly scores using a deviation measurement circuit that compares current temporal graph patterns with learned baseline patterns stored in a reference memory.

The present invention discloses a hardware-implemented computational procedure for privacy-preserving real-time zero-day threat detection in encrypted network traffic, wherein the overall operation is governed by a sequence of coordinated processing stages executed across interconnected processing units. Initially, encrypted packet streams received through a network interface controller are temporarily stored in a packet buffering unit, after which a metadata extraction unit performs feature derivation without decrypting payload contents. The metadata extraction unit utilizes a header parsing circuit to isolate protocol-independent attributes such as packet length, flow direction indicators, and session identifiers, while a timing circuit computes precise inter-arrival intervals using a synchronized clock signal. The extracted attributes are normalized and encoded into structured feature representations using fixed-length encoding registers, thereby ensuring uniformity for subsequent graph-based processing.

Following feature extraction, a temporal graph construction unit generates a dynamic graph representation of network communications. This unit employs a hashing circuit to assign unique identifiers to communication entities, ensuring that endpoint identities are preserved in anonymized form. A memory-backed adjacency matrix generator maintains relational mappings between entities, while a time-indexed edge encoding processor associates each communication event with temporal markers and statistical weights. The graph evolves continuously through a sliding time window mechanism implemented using a circular buffer and timing control circuitry, wherein outdated edges exceeding a predefined temporal threshold are removed and new interactions are incorporated in real time. Edge weights are recalibrated based on both frequency and recency of communication events using weighted accumulation circuits, thereby enabling the graph to reflect dynamic behavioral patterns.

The constructed temporal graph is subsequently distributed to a plurality of distributed graph processing devices, each comprising specialized computation circuits configured to execute iterative message passing operations. Within each device, node feature vectors are processed using matrix multiplication arrays that perform linear transformations, followed by temporal aggregation registers that accumulate information from neighboring nodes across sequential time intervals. Activation processing circuits introduce non-linear transformations, enabling the system to learn complex relational dependencies. These operations are repeated over multiple iterations to propagate contextual information across the graph structure, thereby generating refined node representations that capture both structural and temporal characteristics of network interactions.

Each distributed graph processing device computes local model parameter updates based on the processed graph data, wherein the updates reflect learned representations of normal and anomalous communication behavior. Prior to transmission, the local updates are subjected to compression using data reduction circuits to minimize communication overhead. Subsequently, a cryptographic masking circuit applies randomized masking values generated by a pseudo-random number generation circuit, ensuring that the updates remain confidential during transmission. The masked updates are transmitted to a federated coordination processor through a secure communication interface, wherein a synchronization control unit manages asynchronous arrival of updates from multiple distributed devices.

The federated coordination processor incorporates a secure aggregation unit that combines the received masked updates using homomorphic accumulation registers. The aggregation process is performed without removing the masking values at the individual update level, thereby preventing disclosure of local information. Upon completion of aggregation, the masking values are neutralized to derive a global model parameter set representing the collective learning of all distributed devices. In certain embodiments, a validation circuit assigns trust scores to individual devices based on consistency and reliability of their updates, and the aggregation process incorporates weighted accumulation to enhance robustness against anomalous or adversarial contributions.

The updated global model parameters are redistributed to the distributed graph processing devices for subsequent training iterations, thereby enabling continuous refinement of the detection model. Concurrently, an inference processor applies the global model to newly constructed temporal graph data to evaluate ongoing network activity. The inference processor includes a deviation measurement circuit that compares current graph patterns against baseline patterns stored in reference memory, generating anomaly scores indicative of deviations from learned behavior. A threshold comparison circuit classifies these scores to identify potential zero-day threats, wherein the threshold may be dynamically adjusted based on system conditions and historical observations.

Upon detection of anomalous behavior, an explainability processor is activated to provide interpretability of the detection outcome. The explainability processor employs a perturbation control circuit to selectively modify node attributes, edge connections, and temporal sequences within the graph. A sensitivity computation circuit evaluates variations in inference outputs resulting from these perturbations, thereby quantifying the contribution of individual graph components to the detection decision. The computed contribution scores are ranked to identify the most influential nodes, edges, and temporal segments associated with the anomaly, and the results are formatted into structured explanatory data suitable for analysis and visualization.

Finally, an alert generation unit encodes the detection results and explanatory information into structured notification signals, which are transmitted to external monitoring systems through a communication interface. A response interface, coupled with a traffic control circuit, initiates mitigation actions based on the detected threat, including blocking, rerouting, or throttling of network flows associated with anomalous behavior. The entire procedure operates in a continuous and adaptive manner, wherein the temporal graph is dynamically updated, the distributed model is iteratively trained through federated coordination, and detection decisions are refined in real time. By integrating metadata-based analysis, temporal graph processing, distributed learning, secure aggregation, and explainable inference within a hardware-oriented architecture, the described system achieves accurate and privacy-preserving detection of zero-day threats in encrypted network environments.

Referring to an embodiment of the invention, the system is realized as a dedicated hardware apparatus comprising a network interface controller connected to one or more high-speed communication channels for receiving encrypted packet streams. The network interface controller is coupled with a packet buffering unit and a hardware traffic parsing circuit configured to extract metadata features without accessing encrypted payload contents. The extracted features include packet length distributions, inter-arrival times, flow directionality, protocol header indicators, and session continuity markers.

The metadata is forwarded to a temporal graph construction circuit comprising a memory-backed adjacency matrix generator and a time-indexed edge encoding unit. The construction circuit continuously updates a dynamic graph representation wherein each node corresponds to a unique network endpoint identified by hashed identifiers, and edges represent communication events annotated with temporal stamps and statistical attributes. A sliding time window mechanism is implemented using a hardware timer and circular buffer to ensure real-time graph evolution.

Each edge processing node in the distributed network includes a dedicated graph computation processor configured to execute a temporal graph neural network. The processor comprises matrix multiplication arrays, activation function units, and temporal aggregation registers designed to perform message passing operations across graph nodes over sequential time steps. The temporal graph neural network incorporates recurrent update mechanisms to capture evolving communication patterns and detect deviations indicative of anomalous behavior.

A federated coordination unit is implemented as a central control processor interfaced with multiple edge nodes through a secure communication bus. The coordination unit includes a model aggregation circuit configured to receive encrypted gradient updates from the edge nodes. A secure aggregation mechanism, implemented using homomorphic accumulation registers and cryptographic masking units, ensures that individual node contributions remain confidential during aggregation. The updated global model parameters are redistributed to the edge nodes for subsequent training iterations.

The inference subsystem comprises a graph evaluation processor configured to apply the trained model to incoming graph data streams. The processor computes anomaly scores based on deviations from learned temporal interaction patterns and classifies events using a thresholding circuit. Upon detection of a potential zero-day threat, the system activates an alert generation unit interfaced with external security management systems.

The explainability functionality is implemented through a dedicated attribution circuit that performs sensitivity analysis on the graph neural network outputs. The circuit computes importance scores for nodes and edges by perturbing graph inputs and measuring variations in output activations. A ranking unit then identifies the most influential components contributing to the detection, and an output formatter generates structured explanations suitable for visualization or audit purposes.

In an exemplary operation, the system receives encrypted traffic from a corporate network, constructs a temporal interaction graph of devices, and processes the graph using distributed learning nodes. When an anomalous communication pattern emerges, such as irregular burst transmissions between previously unassociated endpoints, the system detects the deviation through the temporal graph neural model and flags it as a potential zero-day attack. Simultaneously, the explainability circuit identifies the specific communication edges and time intervals responsible for the anomaly, thereby enabling targeted investigation.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A system for privacy-preserving real-time zero-day threat detection in encrypted network traffic, comprising
a network interface controller configured to receive encrypted packet streams from one or more communication channels;
a packet buffering unit operatively coupled to the network interface controller and configured to temporarily store incoming packets;
a metadata extraction unit connected to the packet buffering unit and configured to derive non-payload attributes including packet size, inter-arrival time, directional indicators, and session identifiers;
a temporal graph construction unit operatively connected to the metadata extraction unit and comprising a memory structure and a time-indexed adjacency generation processor configured to construct and continuously update a dynamic graph representation of communication entities and their temporal interactions;
a plurality of distributed graph processing devices each comprising a graph computation processor configured to perform iterative message passing operations on the dynamic graph representation;
a federated coordination processor configured to communicate with the plurality of distributed graph processing devices through a secure communication interface and to aggregate model parameter updates without receiving raw data;
a secure aggregation unit associated with the federated coordination processor and configured to encrypt and combine parameter updates using masking and accumulation circuitry;
an inference processor configured to apply aggregated model parameters to newly constructed temporal graph data to detect anomalous communication patterns; and
an explainability processor operatively connected to the inference processor and configured to determine contribution scores of nodes, edges, and temporal sequences associated with detected anomalies and generate interpretable outputs indicative of zero-day threats, and wherein the federated coordination processor is further configured to perform weighted aggregation of parameter updates by assigning trust scores to distributed graph processing devices based on consistency of historical updates stored in a validation memory, and applying the trust scores as weighting factors during accumulation within the secure aggregation unit to influence the contribution of each device to the global model parameter set.

2. The system of claim 1, wherein the metadata extraction unit comprises a header parsing circuit and a timing analysis circuit, wherein the header parsing circuit isolates protocol-independent attributes from encrypted packets and the timing analysis circuit computes inter-packet temporal intervals using a hardware timer, thereby enabling feature extraction without accessing encrypted payload contents, and the temporal graph construction unit further comprises a sliding time window controller implemented using a circular memory buffer and a clock synchronization circuit, wherein the sliding time window controller updates graph edges based on temporally bounded communication events and removes stale interactions beyond a predefined duration to maintain real-time graph relevance.

3. The system of claim 1, wherein each of the distributed graph processing devices comprises a matrix computation array, a temporal aggregation register, and an activation processing unit, wherein the matrix computation array performs neighborhood feature transformations, the temporal aggregation register accumulates sequential interaction information, and the activation processing unit applies non-linear transformations to produce updated node representations, and the federated coordination processor further comprises a synchronization control unit configured to manage asynchronous update cycles from the plurality of distributed graph processing devices, thereby accommodating heterogeneous processing capabilities and variable network latencies among the distributed devices.

4. The system of claim 1, wherein the secure aggregation unit comprises a cryptographic masking circuit and a homomorphic accumulation register, wherein the cryptographic masking circuit applies randomization to locally computed parameter updates prior to transmission and the homomorphic accumulation register combines masked updates to derive a global model without revealing individual contributions, and the inference processor comprises a threshold comparison circuit and an anomaly scoring unit, wherein the anomaly scoring unit computes deviation measures based on learned temporal graph patterns and the threshold comparison circuit classifies communication behavior as normal or anomalous based on predefined or dynamically adjusted thresholds.

5. The system of claim 1, wherein the explainability processor comprises a perturbation generation circuit and a sensitivity evaluation unit, wherein the perturbation generation circuit modifies selected nodes and edges within the temporal graph and the sensitivity evaluation unit computes variations in inference outputs to determine relative importance of graph components contributing to detected anomalies, and further comprising an alert generation unit operatively connected to the inference processor and configured to transmit notification signals to external security systems, and a response interface configured to initiate predefined mitigation actions including traffic isolation or access restriction upon detection of a zero-day threat.

6. The system of claim 1, wherein the network interface controller, metadata extraction unit, temporal graph construction unit, federated coordination processor, inference processor, and explainability processor are integrated within a hardware computing apparatus comprising interconnected processing circuits and memory elements, thereby enabling real-time operation with reduced latency and enhanced data privacy without reliance on centralized raw data storage.

7. The system of claim 1, wherein the temporal graph construction unit is further configured to encode each communication event into a multi-dimensional edge representation by sequentially writing temporal stamps, directional indicators, and statistical weights into a structured memory layout, and wherein the time-indexed adjacency generation processor updates edge connectivity by executing a deterministic insertion routine that aligns incoming metadata with pre-existing node identifiers through a hash-based lookup table, followed by conditional edge creation or augmentation depending on whether a prior interaction between corresponding nodes is detected within an active time window.

8. The system of claim 3, wherein the sliding time window controller is further configured to implement a dual-phase update operation comprising a forward insertion phase and a backward pruning phase, wherein the forward insertion phase appends newly observed communication edges into a circular buffer with synchronized timestamp tagging, and the backward pruning phase traverses the buffer using a decremental pointer controlled by a timing circuit to identify and remove edges exceeding a temporal threshold, followed by recalculation of adjacency relationships through a memory compaction routine that preserves contiguous storage of valid graph elements.

9. The system of claim 4, wherein the graph computation processor is further configured to perform node feature transformation by executing a staged computation sequence in which input feature vectors are first loaded into a matrix computation array, followed by a weighted multiplication operation using locally stored parameter matrices, and subsequently accumulated across neighboring nodes through a controlled data propagation path governed by an address generation circuit that dynamically selects adjacent node indices from the adjacency matrix, wherein the aggregated results are stored in temporal registers indexed by sequential time steps, and wherein the temporal aggregation register is further configured to maintain a rolling sequence of node state representations across multiple time intervals by shifting stored values through a register chain synchronized with a clock signal, and wherein the aggregation operation combines current and prior node states using a controlled accumulation sequence that preserves temporal ordering, thereby enabling the graph computation processor to capture sequential dependencies without overwriting historical state information.

10. The system of claim 5, wherein the synchronization control unit of the federated coordination processor is further configured to manage asynchronous parameter update reception by assigning sequence identifiers to incoming updates, buffering the updates in a staging memory, and executing an ordering routine that aligns updates based on arrival time and device identity, followed by conditional aggregation once a predefined quorum of updates is reached or a timeout condition is satisfied, thereby enabling coordinated model update cycles under variable communication delays.

11. The system of claim 6, wherein the cryptographic masking circuit is further configured to generate masking values using a pseudo-random sequence derived from a seed stored in a secure register, and to apply the masking values to parameter updates through an element-wise transformation operation prior to transmission, and wherein the homomorphic accumulation register combines the masked updates using additive accumulation while preserving the masked state until a coordinated demasking operation is executed using complementary masking values, and wherein the secure aggregation unit is further configured to perform integrity verification of received parameter updates by computing a verification value using a checksum generation circuit and comparing the computed value with a transmitted reference value, and wherein only verified updates are forwarded to the homomorphic accumulation register for inclusion in the aggregated model parameter set.

12. The system of claim 7, wherein the anomaly scoring unit is further configured to compute deviation measures by executing a comparison routine between current node representations and baseline representations stored in a reference memory, wherein the comparison routine calculates differences across multiple feature dimensions using a parallel evaluation circuit and aggregates the differences into a composite anomaly score using a weighted summation sequence controlled by a programmable register.

13. The system of claim 7, wherein the threshold comparison circuit is further configured to dynamically adjust classification thresholds by monitoring historical anomaly scores stored in a buffer memory and applying a recalibration routine that updates threshold values based on statistical distribution characteristics derived from the stored scores, wherein the recalibration routine is executed at periodic intervals determined by a timing controller.

14. The system of claim 8, wherein the perturbation generation circuit is further configured to selectively alter graph components by modifying node feature values, removing or inserting edges, and reordering temporal sequences according to a controlled perturbation schedule stored in a configuration memory, and wherein each perturbation is applied in isolation to generate modified graph instances for evaluation, and wherein the sensitivity evaluation unit is further configured to compute contribution scores by executing a differential analysis routine that measures variations in inference outputs between original and perturbed graph instances, and accumulates the variations across multiple perturbation cycles using an accumulation register to derive stable importance rankings of graph components.

15. The system of claim 9, wherein the alert generation unit is further configured to construct structured notification signals by encoding anomaly scores, contributing graph components, and temporal identifiers into a formatted data packet using a serialization circuit, and to transmit the formatted data packet through a communication interface using a prioritized transmission sequence controlled by a scheduling circuit.

16. The system of claim 9, wherein the response interface is further configured to execute mitigation actions by generating control signals based on detected anomalies, wherein the control signals are transmitted to a traffic control circuit that identifies associated network flows through a lookup operation on stored session identifiers and applies flow-level modifications including blocking, rate limiting, or rerouting through a programmable switching circuit.
